(19) United States
(12) Patent Application Publication
(10) Pub. No.: US 2015/0046007 A1
(43) Pub. Date: Feb. 12, 2015

(54) ELECTRIC POWER GENERATION CONTROL SYSTEM FOR HYBRID AUTOMOBILE

(71) Applicant: HONDA MOTOR CO., LTD., Tokyo (JP)

(72) Inventors: Teruo Wakashiro, Wako-shi (JP); Hiroshi Tagami, Wako-shi (JP); Toru Nakasako, Wako-shi (JP)

(73) Assignee: HONDA MOTOR CO., LTD., Tokyo (JP)

(21) Appl. No.: 14/385,552

(22) PCT Filed: Apr. 9, 2013
(86) PCT No.: PCT/JP2013/061341

§ 371 Date: Sep. 16, 2014

(30) Foreign Application Priority Data
Apr. 11, 2012 (JP) 2012-090314
May 22, 2012 (JP) 2012-116341

(51) Int. Cl. B60W 20/00; B60W 10/30; B60W 10/08; B60W 10/26; H02P 9/04; B60W 10/06

(52) U.S. Cl. CPC B60W 20/10; H02P 9/04; B60W 10/06; B60W 10/08; B60W 10/26; B60W 10/30; Y10S 903/93
USPC 701/22; 180/65.265; 903/930

(57) ABSTRACT

A control device judges whether electric power generation of an electric generator is to be performed on the basis of a state of a storage battery. When permitting the electric power generation, the control device sets an electric power generation amount equivalent to an output required for cruising, depending on a traveling state, and also sets an additional electric power generation amount, depending on an electric power amount required in a vehicle state and the traveling state. The control device controls an internal combustion engine and the electric generator on the basis of the electric power generation amount and the additional electric power generation amount.

### TECHNICAL FIELD

The present invention relates to an electric power generation control system for a hybrid automobile, comprising: an electric generator driven by an internal combustion engine; a storage battery storing electric power generated by the electric generator; and a control device controlling the internal combustion engine and the electric generator.

### BACKGROUND ART

The following technique is publicly known from Patent Literature 1 listed below for a series hybrid automobile having an EV traveling mode in which the automobile travels by driving an electric motor only by using electric power stored in a storage battery and a series traveling mode in which the automobile travels by driving the electric motor by using electric power generated in an electric generator driven by an internal combustion engine. In the technique, start of the internal combustion engine driving the electric generator is judged and an electric power generation amount of the electric generator is determined based on a state of charge of the storage battery and a requested drive force of the electric motor which is derived from a vehicle speed, an accelerator pedal opening degree, and the like.

Moreover, the following technique is publicly known from Patent Literature 2 listed below for a parallel hybrid automobile having two drive source systems of an internal combustion engine and an electric motor. This automobile is capable of traveling by only the internal combustion engine, by only the electric motor, and by both of the internal combustion engine and the electric motor. The internal combustion engine is basically operated at a constant rotational speed at the most fuel efficient point at which the fuel efficiency is best. When there is surplus in an output of the internal combustion engine, the storage battery is charged by performing electric power generation with the surplus output.

### CITATION LIST

### Patent Literatures

PTL1: WO2011/078189

PTL2: Japanese Patent Application Laid-open No. 09-224304

### SUMMARY OF INVENTION

### Technical Problem

Meanwhile, a plug-in hybrid automobile basically performs EV traveling in which the automobile travels by using electric power stored in a storage battery. An electric generator is driven by the internal combustion engine to charge the storage battery only when the state of charge of the storage battery becomes low. Hence, the frequency of the electric generator operating is naturally lower than hybrid automobiles other than the plug-in hybrid automobile. Accordingly, in the plug-in hybrid automobile, it is desirable to use an internal combustion engine small in size and displacement as the internal combustion engine driving the electric generator.

In the technique described in Patent Literature 1 above, a so-called “requested output following type power generation control” is performed. In this control, the necessity of driving the internal combustion engine and the electric power generation amount of the electric generator are determined from the requested drive force of the electric motor and the state of charge of the storage battery. In this respect, a recent series hybrid automobile equipped with a relatively small internal combustion engine has the following problems compared to the conventional series hybrid automobile equipped with a relatively large internal combustion engine. The rotational speed of the internal combustion engine is high when the requested drive force of the electric motor is large. Accordingly, the rotational speed deviates largely from the most fuel efficient point and the fuel efficiency drastically deteriorates during series traveling. Moreover, there is a possibility that vibrations and noise may increase due to increase in rotational speed of the internal combustion engine.

Moreover, in the technique described in Patent Literature 2, a so-called “fixed-point operation type electric power generation control” is performed. In this control, the internal combustion engine is operated at the most fuel efficient point during series traveling. However, in the recent series hybrid automobile including the relatively small internal combustion engine, the electric power generation amount of the electric generator driven by the internal combustion engine cannot satisfy the requested drive force of the electric motor. Accordingly, there is a possibility that the storage battery tends to be over discharged and maintaining of an energy level is made difficult.

The present invention has been made in view of the circumstances described above and an object thereof is to provide an electric power generation control system for a hybrid automobile which is capable of compensating weak points of the “requested output following type electric power generation control” and the “fixed-point operation type electric power generation control” and satisfying a requested drive force of an electric motor while maintaining a state of charge of a storage battery by generating electric power with a small internal combustion engine.

### Solution to Problem

In order to achieve the object, according to a first feature of the present invention, there is provided an electric power generation control system for a hybrid automobile, comprising: an electric generator driven by an internal combustion engine; a storage battery storing electric power generated by the electric generator; and a control device controlling the internal combustion engine and the electric generator, wherein the control device judges whether electric power generation of the electric generator is to be performed depending on a state of the storage battery, when permitting the electric power generation, the control device sets an electric power generation amount equivalent to an output required for cruising, depending on a traveling state, and also sets an additional electric power generation amount according to an electric power amount required depending on a vehicle state and the traveling state, and the control device controls the internal combustion engine and the electric generator on the basis of the electric power generation amount and the additional electric power generation amount.

Further, according to a second feature of the present invention, in addition to the configuration of the first feature, there is provided the electric power generation control system for a hybrid automobile, wherein the control device judges whether the electric power generation is to be performed on the basis of a depth of discharge of the storage battery.

Further, according to a third feature of the present invention, in addition to the configuration of the first or second feature, there is provided the electric power generation control system for a hybrid automobile, wherein the control device judges whether the electric power generation is to be performed on the basis of a state of charge of the storage battery.

Further, according to a fourth feature of the present invention, in addition to the configuration of any one of the first to third features, there is provided the electric power generation control system for a hybrid automobile, wherein the control device sets the electric power generation amount on the basis of a vehicle speed.

Further, according to a fifth feature of the present invention, in addition to the configuration of the fourth feature, there is provided the electric power generation control system for a hybrid automobile, wherein the control device derives a rolling resistance and an air resistance during traveling on the basis of the vehicle speed and sets the electric power generation amount on the basis of the derived rolling resistance and the derived air resistance.

Further, according to a sixth feature of the present invention, in addition to the configuration of any one of the first to fifth features, there is provided the electric power generation control system for a hybrid automobile, wherein the control device sets the additional electric power generation amount on the basis of an estimated value of a gradient of a road surface.

Further, according to a seventh feature of the present invention, in addition to the configuration of any one of the first to sixth features, there is provided the electric power generation control system for a hybrid automobile, wherein the control device sets the additional electric power generation amount on the basis of a depth of discharge of the storage battery.

Further, according to an eighth feature of the present invention, in addition to the configuration of any one of the first to seventh features, there is provided the electric power generation control system for a hybrid automobile, wherein the control device sets the additional electric power generation amount on the basis of a state of charge of the storage battery.

Further, according to a ninth feature of the present invention, in addition to the configuration of any one of the first to eighth features, there is provided the electric power generation control system for a hybrid automobile, wherein the control device sets the additional electric power generation amount on the basis of a vehicle speed.

Further, according to a tenth feature of the present invention, in addition to the configuration of any one of the first to ninth features, there is provided the electric power generation control system for a hybrid automobile, further comprising an air conditioner performing air conditioning in a vehicle compartment, wherein the control device judges whether the air conditioner is operating, and when the air conditioner is operating, the control device sets the additional electric power generation amount depending on a requested temperature of the air conditioner.

Further, according to an eleventh feature of the present invention, in addition to the configuration of any one of the first to tenth features, there is provided the electric power generation control system for a hybrid automobile, wherein the control device corrects the additional electric power generation amount depending on a vehicle speed.

Further, according to a twelfth feature of the present invention, in addition to the configuration of any one of the first to eleventh features, there is provided the electric power generation control system for a hybrid automobile, wherein the control device sets a rotational speed of the internal combustion engine on the basis of the electric power generation amount and the additional electric power generation amount.

Further, according to a thirteenth feature of the present invention, there is provided an electric power generation control system for a hybrid automobile, comprising: an electric generator driven by an internal combustion engine; a storage battery storing electric power generated by the electric generator; an air conditioner performing air conditioning in a vehicle compartment; and a control device controlling the air conditioner, the internal combustion engine, and the electric generator, wherein the control device judges whether electric power generation is to be performed on the basis of at least any one of parameters including a depth of discharge and a state of charge of the storage battery, when permitting the electric power generation, the control device derives at least any one of resistances including an air resistance and a rolling resistance during traveling on the basis of a vehicle speed and sets an electric power generation amount equivalent to an output required for cruising on the basis of the derived resistance, and the control device sets an additional electric power generation amount on the basis of at least any one of parameters including an estimated value of a gradient of a road surface, the depth of discharge of the storage battery, the state of charge of the storage battery, the vehicle speed, and a requested temperature of the air conditioner, and sets a rotational speed of the internal combustion engine on the basis of the set electric power generation amount and the set additional electric power generation amount.

Here, an electric compressor 22 and an electric heater 23 of an embodiment correspond to the air conditioner of the present invention; an electric power generation amount PGENRL equivalent to an output required for cruising at each vehicle speed of the embodiment corresponds to the electric power amount of the present invention; and an additional electric power generation amount PGENBASE in electric power generation at each vehicle speed of the embodiment corresponds to the additional electric power generation amount of the present invention.

### Advantageous Effects of Invention

According to the first feature of the present invention, the electric power generation control system for a hybrid automobile includes the electric generator driven by the internal combustion engine, the storage battery storing electric power generated by the electric generator, and the control device controlling the internal combustion engine and the electric generator. The control device judges whether the electric power generation of the electric generator is to be performed depending on the state of the storage battery. When permitting the electric power generation, the control device sets the electric power generation amount capable of satisfying the output required for cruising, depending on a traveling state, and also sets the additional electric power generation amount depending on an electric power amount required currently or in the future due to the vehicle state and the traveling state. The control device controls the internal combustion engine and the electric generator on the basis of the electric power generation amount and the additional electric power generation amount. With this configuration, the electric power capable of satisfying the output required for the vehicle to cruise is satisfied by electric power amount generated by the electric generator and is further supplemented with the additional electric power generation amount for a predetermined extra amount, while electric power required when the vehicle is temporarily accelerating or performing EV traveling is satisfied by electric power of the storage battery. The internal combustion engine can be thus reduced in size and be operated near the most fuel efficient point. Accordingly, reduction in fuel consumption, reduction in exhaust amount of CO₂, and reduction in noise of the internal combustion engine are achieved and the required state of charge is secured by preventing the tendency of the storage battery to over discharge. Moreover, the electric power generation amount capable of satisfying the output required for cruising is set depending on the traveling state. Thus, the storage battery can be charged by a surplus output of the electric generator in downhill or deceleration. Accordingly, the frequency of electric power generation by the electric generator is increased and the state of charge of the storage battery is thereby secured with no electric power generation of large output, which reduces the efficiency of the internal combustion engine, being performed.

According to the second feature of the present invention, whether the electric power generation is to be performed is judged based on the depth of discharge of the storage battery. Accordingly, it is possible to inhibit EV traveling when the state of charge of the storage battery is insufficient and thereby prevent over discharge.

According to the third feature of the present invention, whether the electric power generation is to be performed is judged based on the state of charge of the storage battery. Accordingly, it is possible to inhibit EV traveling when the state of charge of the storage battery is insufficient and thereby prevent over discharge.

According to the fourth feature of the present invention, the electric power generation amount is set based on the vehicle speed. Accordingly, the electric power generation amount capable of satisfying the output required for cruising which increases as the vehicle speed increases can be secured by the electric power generation amount of the electric generator.

According to the fifth feature of the present invention, the rolling resistance and the air resistance during traveling are derived based on the vehicle speed and the electric power generation amount is set based on the derived rolling resistance and the derived air resistance. Accordingly, the electric power generation amount capable of satisfying the output required for cruising can be accurately set.

According to the sixth feature of the present invention, the additional electric power generation amount is set based on the estimated value of the gradient of the road surface. Accordingly, the electric power generation amount capable of satisfying the output required for cruising which changes depending on the estimated value of the gradient of the road surface can be obtained from the electric generator.

According to the seventh feature of the present invention, the additional electric power generation amount is set based on the depth of discharge of the storage battery. Accordingly, it is possible to suppress the additional electric power generation amount to a minimum required amount and thereby further reduce the fuel consumption of the internal combustion engine.

According to the eighth feature of the present invention, the control device sets the additional electric power generation amount on the basis of the state of charge of the storage battery. Accordingly, it is possible to suppress the additional electric power generation amount to the minimum required amount and thereby further reduce the fuel consumption of the internal combustion engine.

According to the ninth feature of the present invention, the control device sets the additional electric power generation amount on the basis of the vehicle speed. Accordingly, it is possible to suppress the additional electric power generation amount to the minimum required amount and thereby further reduce the fuel consumption of the internal combustion engine. Moreover, whether surplus electric power generation is possible can be judged from the vehicle speed, i.e. the surplus electric power generation can be performed in an optimal vehicle speed region. Accordingly, it is possible to suppress vibrations at low speed and excessive electric power generation due to driving at high speed and thereby improve a product quality.

According to the tenth feature of the present invention, whether the air conditioner is operating is judged. When the air conditioner is operating, the additional electric power generation amount is set depending on the requested temperature of the air conditioner. Accordingly, the additional electric power generation amount can satisfy electric power consumed by the air conditioner.

According to the eleventh feature of the present invention, the additional electric power generation amount is corrected depending on the vehicle speed. Accordingly, the electric power generation amount capable of satisfying the output required for cruising which changes depending on the vehicle speed can be secured by the electric generator.

According to the twelfth feature of the present invention, the rotational speed of the internal combustion engine is set based on the electric power generation amount and the additional electric power generation amount. Accordingly, electric power according to the electric power generation amount and the additional electric power generation amount can be generated by the electric generator.

According to the thirteenth feature of the present invention, the control device determines whether electric power generation of the electric generator is to be performed depending on the state of the storage battery. When permitting the electric power generation, the control device sets the electric power generation amount required for cruising output, depending on the vehicle speed, and also sets the additional electric power generation amount depending on the electric power amount required due to the vehicle state and the traveling state. The control device controls the internal combustion engine and the electric generator on the basis of the electric power generation amount and the additional electric power generation amount. With this configuration, the electric power capable of satisfying the output required for the vehicle to cruise is satisfied by the electric power amount generated by the electric power generator and is further supplemented with the additional electric power generation amount for a predetermined extra amount, while electric power required when the vehicle is temporarily accelerating or performing the EV traveling is obtained from the electric power of the storage battery. The internal combustion engine can be thus reduced in size and be operated near the most fuel efficient point. Accordingly, reduction in fuel consumption, reduction in exhaust amount of CO₂, and reduction in noise of the internal combustion engine are achieved while the required state of charge is secured by preventing the tendency of the storage battery to over discharge. Moreover, the electric power generation amount required for the cruising output is set depending on the traveling state. Thus, the storage battery can be charged by using the surplus output of the electric generator in downhill or deceleration. Accordingly, the frequency of electric power generation by the electric generator is increased and the state of charge of the storage battery is thereby secured with no electric power generation of large output, which reduces the efficiency of the internal combustion engine, being performed.

### BRIEF DESCRIPTION OF DRAWINGS

FIG. 1 is a block diagram showing an overall configuration of a power unit of a hybrid automobile. (execution example 1)

FIG. 2 is a flowchart of an operation determining routine. (execution example 1

FIG. 3 is a flowchart of a depth-of-discharge calculation routine. (execution example 1

FIG. 4 is a flowchart of an electric power generation judgment routine. (execution example 1)

FIG. 5 is a flowchart of an electric power generation amount calculation routine. (execution example 1)

FIG. 6 is a diagram for explaining a method of calculating a depth of discharge. (execution example 1)

### DESCRIPTION OF EMBODIMENT

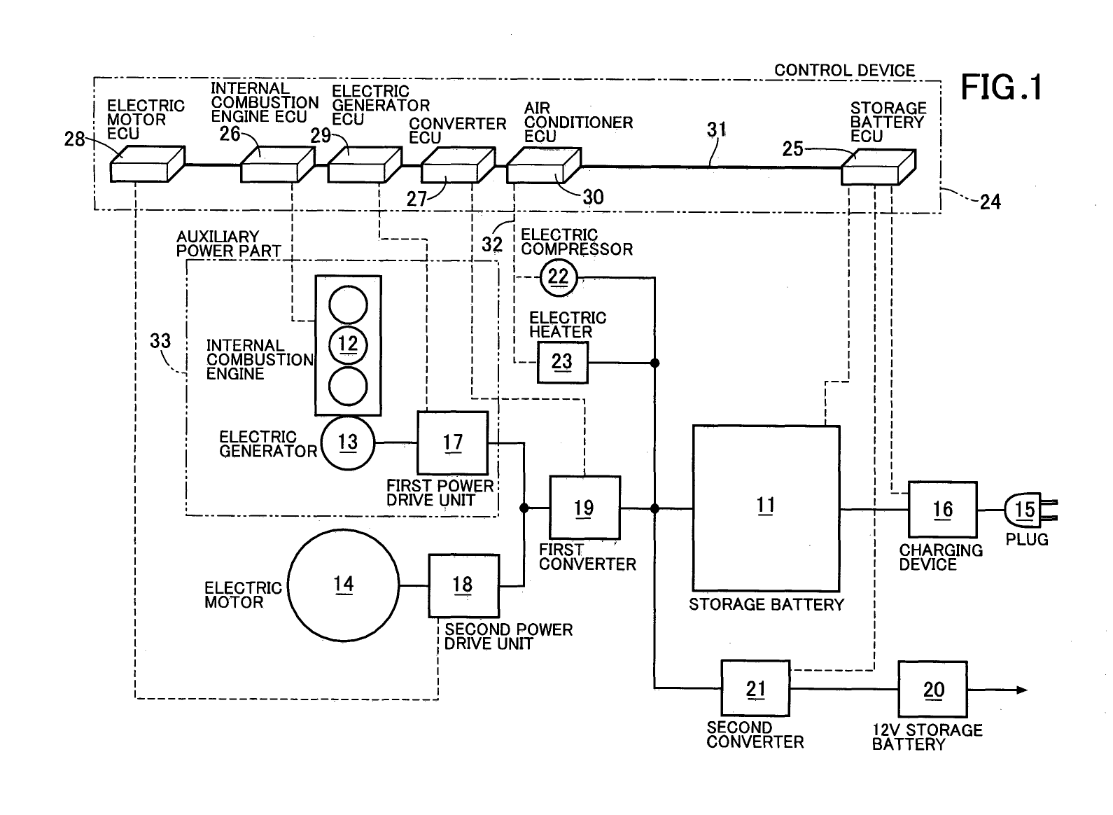

An embodiment or example of the present invention is described below based on FIGS. 1 to 6.

### Example 1

A hybrid vehicle including a storage battery 11 such as a lithium ion (Li-ion) battery is a series hybrid vehicle in which an electric generator 13 is connected to a crankshaft of an internal combustion engine 12 and an electric motor 14 for traveling is connected to a drive wheel. The storage battery 11 includes an external charging plug 15 connectable to an external charging apparatus (omitted in the drawings) for example and can be charged by an external charging device 16 via the external charging plug 15.

The electric generator 13 and the electric motor 14 are a three-phase DC brushless generator and a three-phase DC brushless motor for example. The electric generator 13 is connected to a first power drive unit 17 while the electric motor 14 is connected to a second power drive unit 18. The first and second power drive units 17, 18 each include a PWM inverter performing pulse width modulation (PWM) and including a bridge circuit in which multiple switching elements such as transistors are bridge connected. The first and second power drive units 17, 18 are connected to the storage battery 11 via a first converter 19.

For example, when the electric generator 13 generates electric power by using power of the internal combustion engine 12, the generated AC electric power outputted from the electric generator 13 is converted to DC electric power by the first power drive unit 17; thereafter, the DC electric power is subjected to voltage transformation in the first converter 19 and then charges the storage battery 11, and, the DC electric power is converted to AC electric power again by the second power drive unit 18 and is then supplied to the electric motor 14. Further, for example, when the electric motor 14 is driven, DC electric power outputted from the storage battery 11 or DC electric power obtained by converting electric power outputted from the electric generator 13 with the first power drive unit 17 is converted to AC electric power by the second power drive unit 18 and the AC electric power is supplied to the electric motor 14.

Meanwhile, for example, when a drive force is transmitted from the drive wheel side to the electric motor 14 side in deceleration and the like of the hybrid vehicle, the electric motor 14 functions as an electric generator to generate a so-called regeneration brake force and recovers kinetic energy of a vehicle body as electric energy. When the electric motor 14 is generating electric power, the second power drive unit 18 converts the generated (regenerated) AC electric power outputted from the electric motor 14 to DC electric power. Further, the DC electric power is subjected to voltage transformation in the first converter 19 and charges the storage battery 11.

Moreover, a low-voltage 12V storage battery 20 for driving electric loads including various accessories is connected to the storage battery 11 via a second converter 21. The second converter 21 can step down a voltage between terminals of the storage battery 11 and a voltage between terminals of the first converter 19 to a predetermined voltage value to enable charging of the 12V storage battery 20.

Here, for example, in the case where the state of charge (SOC) of the storage battery 11 is low or in a similar case, a voltage between terminals of the 12V storage battery 20 can be stepped up by the second converter 21 to enable charging of the storage battery 11.

Furthermore, an electric compressor 22 and an electric heater 23 performing air conditioning of a vehicle compartment are connected to the storage battery 11.

A control device 24 controlling a power system of the hybrid vehicle includes, as various ECUs (Electronic Control Unit) including electric circuits such as CPU (Central Processing Unit), a storage battery ECU 25, an internal combustion engine ECU 26, a converter ECU 27, an electric motor ECU 28, an electric generator ECU 29, and an air conditioner ECU 30 which are connected for control.

The electric generator ECU 29 controls an electric power conversion operation of the first power drive unit 17 to control the electric power generation of the electric generator 13 which is performed by using the power of internal combustion engine 12.

The electric motor ECU 28 controls an electric power conversion operation of the second power drive unit 18 to control the drive and the electric power generation of the electric motor 14.

The electric power conversion operations of the first and second power drive units 17, 18 are controlled in accordance with a pulse for driving the transistors of the first and second power drive units 17, 18 to turn on and off in the pulse width modulation (PWM) or the like for example. The operation amounts of the electric generator 13 and the electric motor 14 are controlled in accordance with the duty of the pulse, i.e. the ratio between the on state and the off state.

The storage battery ECU 25 performs controls such as monitoring and protecting of a high-voltage system including the storage battery 11 for example and performs a control of electric power conversion operation of the second converter 21. For example, the storage battery ECU 25 calculates various state quantities such as the state of charge (SOC) of the storage battery 11 on the basis of detection signals respectively of the voltage between the terminals, the current, and the temperature of the storage battery 11. The storage battery ECU 25 is connected to a voltage sensor which detects the voltage of the storage battery 11, a current sensor which detects the current of the storage battery 11, and a temperature sensor which detects the temperature of the storage battery 11 and the detection signals outputted from these sensors are inputted to the storage battery ECU 25.

The internal combustion engine ECU 26 controls fuel supply to the internal combustion engine 12, ignition timing of the internal combustion engine 12, and the like. For example, the internal combustion engine ECU 26 causes a control electric current to flow through an electromagnetic actuator driving a throttle valve and electronically controls the throttle valve in such a way that a valve opening degree is set to one according to an instruction from the storage battery ECU 25. Moreover, when a control following an output requested by a driver is performed, the internal combustion engine ECU 26 performs an electronic control by causing the control current to flow through the electromagnetic actuator driving the throttle valve, depending on an accelerator pedal opening degree. Moreover, the internal combustion engine ECU 26 manages and controls all of the other ECUs. In this respect, the detection signals outputted from various sensors which detect state quantities of the hybrid vehicle are inputted to the internal combustion engine ECU 26.

For example, the various sensors include a vehicle speed sensor which detects a vehicle speed, a cooling water temperature sensor which detects a cooling water temperature of the internal combustion engine 12, an accelerator pedal opening degree sensor which detects the accelerator pedal opening degree, and the like.

The ECUs are connected to a CAN (Controller Area Network) communication first line 31 of the vehicle together with the sensors which detect various states of the hybrid vehicle.

Moreover, the electric compressor 22 and the electric heater 23 are connected to a CAN (Controller Area Network) communication second line 32, which has a slower communication speed than that of the CAN (Controller Area Network) communication first line 31, together with a meter including instruments displaying various states of the hybrid vehicle.

The internal combustion engine 12, the electric generator 13, and the first power drive unit 17 form an auxiliary power part 33 which generates electric power by using the drive force of the internal combustion engine 12.

Next, description is given of an electric power generation control of the hybrid automobile having the configuration described above.

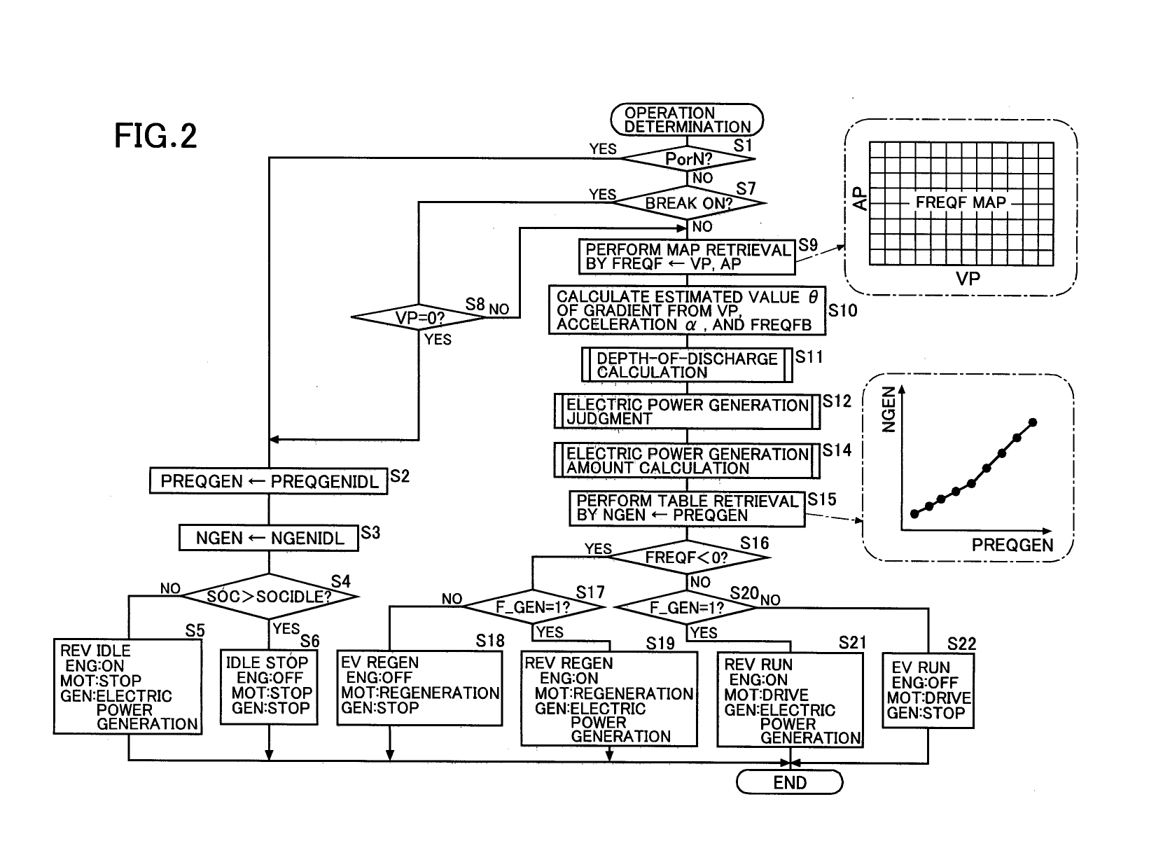

The flowchart of FIG. 2 shows an operation determining routine. In this routine, an operation mode is determined from six types of operation modes for the hybrid automobile.

First, when a range selected by a driver is a “P” range (parking range) or an “N” range (neutral range) in step S1, an electric generator electric power generation output PREQGEN which is an electric power generation amount of the electric generator 13 is set to an electric generator output PREQGENIDL in idling in step S2. Then, in step S3, an electric generator internal combustion engine rotational speed NGEN which is the rotational speed of the internal combustion engine 12 is set to an electric generator internal combustion engine rotational speed NGENIDL in idling. When the state of charge SOC of the storage battery 11 is equal to or lower than an upper limit SOCIDLE of state-of-charge for performing idle electric power generation in subsequent step S4, the operation mode is set to a first mode (REV idling mode) in step S5 and the operation determining routine is terminated. When the state of charge SOC of the storage battery 11 is higher than the upper limit SOCIDLE of state-of-charge for performing idle electric power generation in step S4, the operation mode is set to a second mode (idling stop mode) in step S6 and the operation determining routine is terminated.

The state of charge SOC of the storage battery 11 can be calculated as follows. An integrated charge amount and an integrated discharge amount are calculated by integrating charge and discharge currents detected by the current sensor. Then, the integrated charge amount and the integrated discharge amount are added to or subtracted from an initial state or the state of charge SOC immediately before the start of charging and discharging. Moreover, since an open circuit voltage OCV of the storage battery 11 is in correlation with the state of charge SOC, the state of charge SOC can be also calculated from the open circuit voltage OCV.

The first mode (REV idling mode) is the following mode. In order to increase the state of charge SOC of the storage battery 11, the internal combustion engine 12 is operated to idle and the electric generator 13 is made to generate electric power, in the state where the “P” range (parking range) or the “N” range (neutral range) is selected and the electric motor 14 is stopped. The storage battery 11 is thus charged by the electric power generated by the electric generator 13.

The second mode (idling stop mode) is the following mode. Since the state of charge SOC of the storage battery 11 is sufficient, the internal combustion engine 12 is controlled to stop idling and the electric generator 13 is stopped, in the state where the “P” range or the “N” range is selected and the electric motor 14 is stopped.

Assume the case where, in aforementioned step S1, the range selected by the driver in step S1 is not the “P” range or the “N” range, but is a “D” range (forward traveling range) or an “R” range (reverse traveling range) for example. In this case, when the driver is stepping on the brake pedal in step S7 and the vehicle speed VP detected by the vehicle speed sensor is zero, i.e. the vehicle is not moving, in step S8, the routine proceeds to aforementioned step S2 to step S4 and the first mode of step S5 or the second mode of step S6 is selected.

Assume the case where the driver is not stepping on the brake pedal in step S7 or the case where the vehicle speed VP is not zero in step S8 even though the driver is stepping on the brake pedal, for example, the case where the vehicle is decelerating while traveling forward or backward. In such cases, a requested drive power FREQF which is power requested by the driver to be outputted from the electric motor 14 is retrieved from a map in step S9 by using the vehicle speed VP and the accelerator pedal opening degree AP detected by the accelerator pedal opening degree sensor as parameters.

In subsequent step S10, an estimated value θ of gradient of a road surface on which the vehicle is currently traveling is calculated from the vehicle speed VP, acceleration a calculated by performing time differentiation on the vehicle speed VP, and a previous value FREQFB of the requested drive power FREQF. The estimated value θ of gradient is calculated from Formula (1).

θ=[FREQFB−(Ra+Rr+Rc)]/(W*g) (1)

Here, in Formula (1), Ra represents air resistance, Rr represents rolling resistance, Rc represents acceleration resistance, W represents a vehicle weight, and g represents gravitational acceleration. Ra, Rr, and Rc are calculated respectively from Formulae (2), (3), and (4).

Ra=λ*S*VP² (2)

Rr=W*μ (3)

Rc=α*W (4)

Here, in Formulae (2) to (4), λ represents a coefficient of air resistance, S represents a frontal projected area, VP represents a vehicle speed, μ represents a coefficient of rolling resistance, and a represents acceleration.

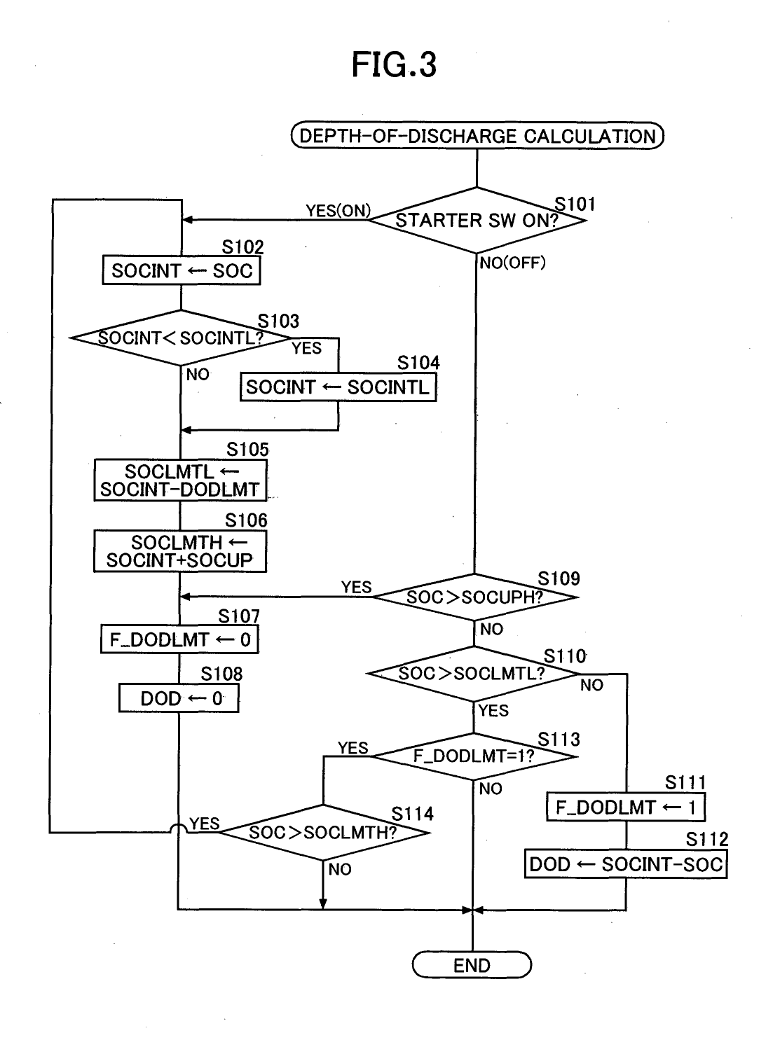

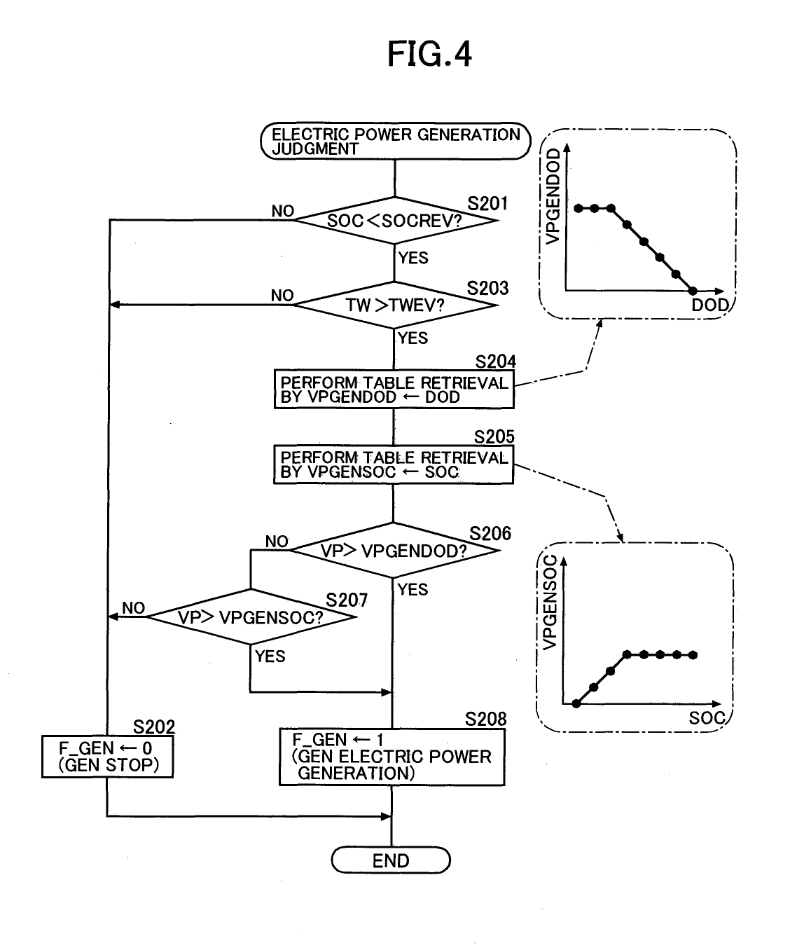

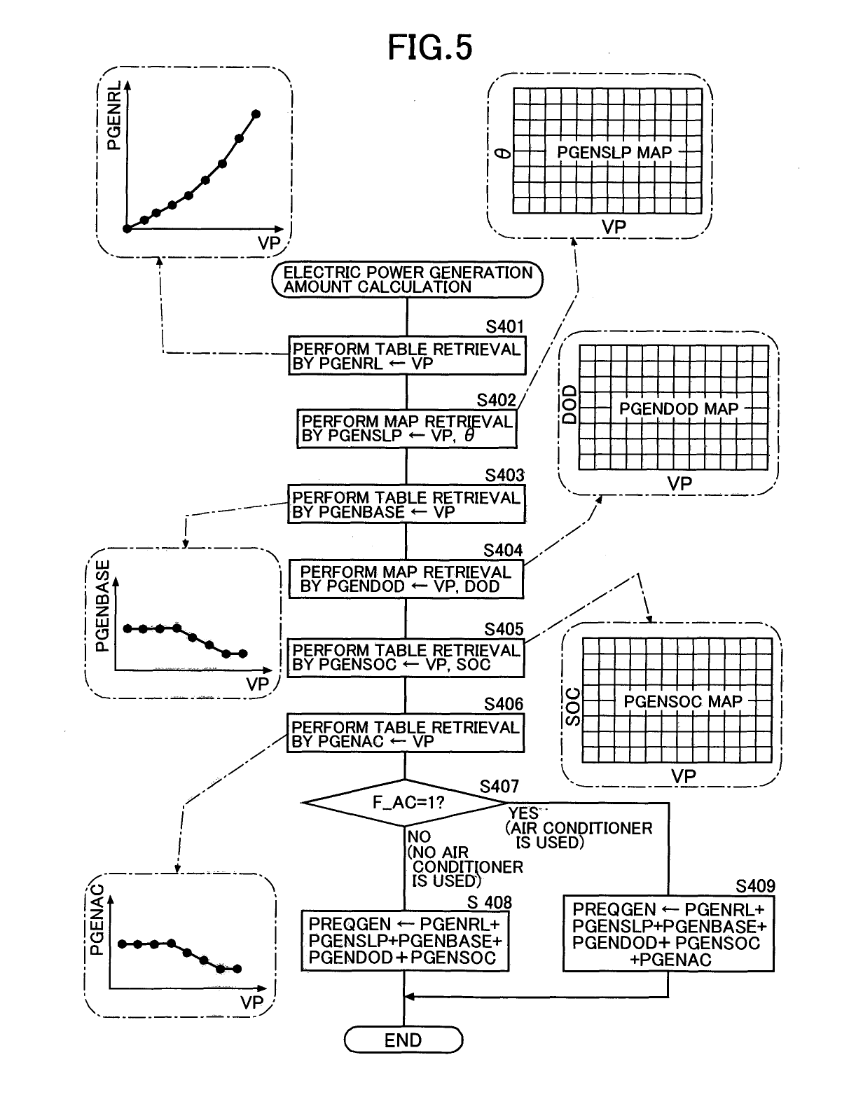

In subsequent step S11, the depth of discharge DOD of the storage battery 11 is calculated. Details of the calculation are described later based on the flowchart of FIG. 3. In subsequent step S12, it is judged whether the internal combustion engine 12 is to be driven to perform electric power generation by the electric generator 13, i.e. whether the electric power generation by the auxiliary power part 33 is to be performed. Details of the determination are described later based on the flowchart of FIG. 4. In the subsequent S14, the electric generator electric power generation output PREQGEN which is the electric power generation amount of the electric generator 13 is calculated. Details of the calculation are described later based on the flowchart of FIG. 5.

In subsequent step S15, the electric generator internal combustion engine rotational speed NGEN which is the rotational speed of the internal combustion engine 12 driving the electric generator 13 is retrieved from a table by using the electric generator electric power generation output PREQGEN calculated in aforementioned step S14 as a parameter. Since the electric generator 13 is connected to and driven by the internal combustion engine 12, the electric generator internal combustion engine rotational speed NGEN increases along with the increase in the electric generator electric power generation output PREQGEN.

When the requested drive power FREQF calculated in aforementioned step S9 is lower than zero, i.e. the electric motor 14 is performing regeneration, in subsequent step S16 and an electric power generation flag F_GEN=“0” (no electric power generation is performed) is set in step S17, the operation mode is set to a third mode (EV regeneration mode) in step S18 and the operation determining routine is terminated. When the electric power generation flag F_GEN=“1” (electric power generation is performed) is set in step S17, the operation mode is set to a fourth mode (REV regeneration mode) in step S19 and the operation determining routine is terminated.

The third mode (EV regeneration mode) is the following mode. The storage battery 11 is charged by causing the electric motor 14 to function as an electric generator by using a drive force reversely transmitted from the drive wheels during deceleration of the vehicle. Meanwhile, the internal combustion engine 12 and the electric generator 13 are stopped.

The fourth mode (REV regeneration mode) is the following mode. The storage battery 11 is charged by causing the electric motor 14 to function as an electric generator by using a drive force reversely transmitted from a drive wheel during deceleration of the vehicle. In addition, the electric generator 13 is driven by the internal combustion engine 12 and the storage battery 11 is charged by using the electric power generated by the electric generator 13. As described above, the charging of the storage battery 11 by the drive of the auxiliary power part 33 is performed in parallel with the charging of the storage battery 11 by the regenerative electric power generation of the electric motor 14 during deceleration of the vehicle. This allows the storage battery 11 to be effectively charged even when the charging by the regenerative electric power generation is insufficient.

When the requested drive power FREQF is zero or higher, i.e. the electric motor 14 is driven, in step S16 and the electric power generation flag F_GEN=“1” (electric power generation is performed) is set in step S20, the operation mode is set to a fifth mode (REV traveling mode) in step S21 and the operation determining routine is terminated. When the electric power generation flag F_GEN=“0” (no electric power generation is performed) is set in step S20, the operation mode is set to a sixth mode (EV traveling mode) in step S22 and the operation determining routine is terminated.

The fifth mode (REV traveling mode) is a mode in which the vehicle travels with the electric motor 14 driven by the electric power generated by the auxiliary power part 33 and/or the electric power stored in the storage battery 11. The internal combustion engine 12, the electric generator 13, and the electric motor 14 are all driven.

The sixth mode (EV traveling mode) is a mode in which the vehicle travels with the auxiliary power part 33 stopped and the electric motor 14 is driven by the electric power stored in the storage battery 11. The internal combustion engine 12 and the electric generator 13 are stopped while the electric motor 14 is driven.

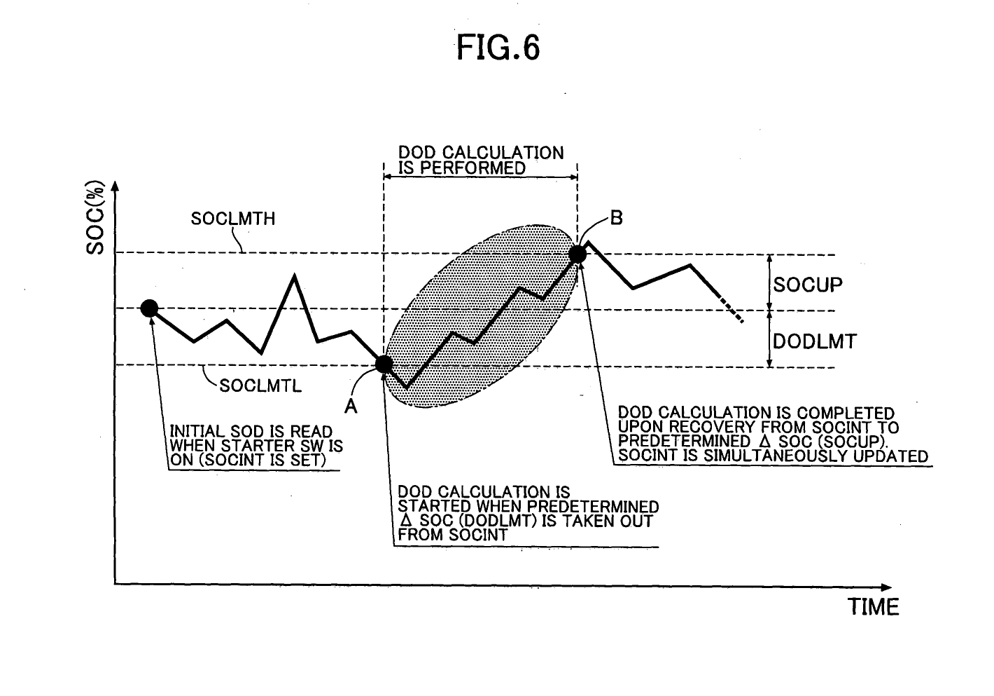

Next, a depth-of-discharge calculation routine which is a subroutine of aforementioned step S11 is described based on the flowchart of FIG. 3 and the explanatory diagram of FIG. 6.

First, when a starter switch is turned on in step S101, in step S102, the state of charge SOC at this time is set as a reference state-of-charge SOCINT for depth-of-discharge calculation. In the subsequent step S103, it is judged whether the reference state-of-charge SOCINT for depth-of-discharge calculation is lower than a lower limit value SOCINTL of reference state-of-charge for depth-of-discharge calculation. When it is determined that the reference state-of-charge SOCINT for depth-of-discharge calculation is lower than the lower limit value SOCINTL of reference state-of-charge for depth-of-discharge calculation, the reference state-of-charge SOCINT for depth-of-discharge calculation is set to the lower limit value SOCINTL of reference state-of-charge for depth-of-discharge calculation in step S104. When it is determined that the reference state-of-charge SOCINT for depth-of-discharge calculation is equal to or higher than the lower limit value SOCINTL of reference state-of-charge for depth-of-discharge calculation, the reference state-of-charge SOCINT for depth-of-discharge calculation is maintained at the value set in step S102.

In subsequent step S105, a lower threshold SOCLMTL for performing depth-of-discharge calculation is set to a value obtained by subtracting a discharge amount DODLMT for judgment of performing depth-of-discharge calculation from the reference state-of-charge SOCINT for depth-of-discharge calculation. In subsequent step S106, an upper threshold SOCLMTH for performing depth-of-discharge calculation is set to a value obtained by adding a charge amount SOCUP for judgment of performing depth-of-discharge calculation to the reference state-of-charge SOCINT for depth-of-discharge calculation. Then, in step S107, a depth-of-discharge calculation flag F_DODLMT is set to “0” (no calculation is performed). Moreover, in step S108, the depth of discharge DOD is set to “0” which is an initial value and the depth-of-discharge calculation routine is terminated.

When the starter switch is turned off or is not set to on in aforementioned step S101, it is judged in step S109 whether the state of charge SOC is higher than an upper limit state-of-charge SOCUPH for performing depth-of-discharge calculation. When it is determined that the state of charge SOC is higher than the upper limit state-of-charge SOCUPH for performing depth-of-discharge calculation, the routine proceeds to aforementioned step S107 and aforementioned step S108 and the depth-of-discharge calculation is not executed. When it is determined that the state of charge SOC is equal to or lower than the upper limit state-of-charge SOCUPH for performing depth-of-discharge calculation in step S109, the routine proceeds to step S110.

In the subsequent step S110, it is judged whether the state of charge SOC is equal to or lower than the lower threshold SOCLMTL for performing depth-of-discharge calculation. When the state of charge SOC is equal to or lower than the lower threshold SOCLMTL for performing depth-of-discharge calculation (see the point A of FIG. 6), the depth-of-discharge calculation flag F_DODLMT is set to “1” (calculation is performed) in step S111 and the depth of discharge DOD is set to a value obtained by subtracting the state of charge SOC from the reference state-of-charge SOCINT for depth-of-discharge calculation in step S112. Then, the depth-of-discharge calculation routine is terminated. When it is determined that the state of charge SOC is higher than the lower threshold SOCLMTL for performing depth-of-discharge calculation in aforementioned step S110, the routine proceeds to step S113.

Then, when the depth-of-discharge calculation flag F_DODLMT is set to “1” (calculation is performed), i.e. the calculation of the depth of discharge DOD is performed, in step S113, it is judged in step S114 whether the state of charge SOC is higher than the upper threshold SOCLMTH for performing depth-of-discharge calculation. When the state of charge SOC is higher than the upper threshold SOCLMTH for performing depth-of-discharge calculation (see the point B of FIG. 6), the routine proceeds to aforementioned steps S102 to S108 and the processing is executed. Thereafter, the depth-of-discharge calculation routine is terminated. In step S102, the processing is executed with the reference state-of-charge SOCINT for depth-of-discharge calculation updated with the state of charge SOC at the time when the routine proceeds from step S114.

When the depth-of-discharge calculation flag F_DODLMT is set to “0” (no calculation is performed) in aforementioned step S113 or it is determined that the state of charge SOC is equal to or lower than the upper limit state-of-charge SOCUPH for performing depth-of-discharge calculation in step S114, the depth-of-discharge calculation routine is terminated.

Next, an electric power generation judgment routine which is a subroutine of aforementioned step S12 is described based on the flowchart of FIG. 4.

First, in step S201, it is determined whether the state of charge SOC of the storage battery 11 is lower than an upper limit state-of-charge SOCREV for performing a REV mode electric power generation. When it is determined that the state of charge SOC of the storage battery 11 is equal to or higher than the upper limit state-of-charge SOCREV for performing REV mode electric power generation, the electric power generation flag F_GEN=“0” is set and the electric power generation by the auxiliary power part 33 is stopped in step S202. Then the electric power generation judgment routine is terminated. Assume the case where it is determined that the state of charge SOC of the storage battery 11 is lower than the upper limit state-of-charge SOCREV for performing REV mode electric power generation in aforementioned step S201, but it is determined that a cooling water temperature TW of the internal combustion engine 12 which is detected by the cooling water temperature sensor is equal to or lower than an upper limit water temperature TWEV for performing EV mode in subsequent step S203. In this case, since warm-up of the internal combustion engine 12 is not completed yet, the electric power generation flag F_GEN=“0” is set and the electric power generation by the auxiliary power part 33 is stopped in step S202. Then, the electric power generation judgment routine is terminated.

When it is determined that the state of charge SOC of the storage battery 11 is lower than the upper limit state-of-charge SOCREV for performing REV mode electric power generation in aforementioned step S201 and it is determined that the cooling water temperature TW of the internal combustion engine 12 which is detected by the cooling water temperature sensor is higher than the upper limit water temperature TWEV for performing EV mode in step S203, a lower limit vehicle speed VPGENDOD for performing electric power generation based on the depth of discharge is retrieved from a table in step S204 by using the depth of discharge DOD as a parameter. The lower limit vehicle speed VPGENDOD for performing electric power generation based on the depth of discharge decreases along with an increase in the depth of discharge DOD. Specifically, once the state of charge of the storage battery 11 is decreased, the auxiliary power part 33 is operated at a low vehicle speed to reduce the frequency of EV traveling and over discharge of the storage battery 11 is thereby suppressed.

In subsequent step S205, a lower limit vehicle speed VPGENSOC for performing electric power generation based on the state of charge is retrieved from a table by using the state of charge SOC as a parameter. The lower limit vehicle speed VPGENSOC for performing electric power generation based on the state of charge decreases along with a decrease in the state of charge SOC. Specifically, once the state of charge of the storage battery 11 is decreased, the auxiliary power part 33 is operated at a low vehicle speed to reduce the frequency of EV traveling and over discharge of the storage battery 11 is thereby suppressed.

In subsequent step S206, it is determined whether the vehicle speed VP is higher than the lower limit vehicle speed VPGENDOD for performing electric power generation based on the depth of discharge. When the vehicle speed VP is equal to or lower than the lower limit vehicle speed VPGENDOD for performing electric power generation based on the depth of discharge, it is determined in step S207 whether the vehicle speed VP is higher than the lower limit vehicle speed VPGENSOC for performing electric power generation based on the state of charge. When the vehicle speed VP is equal to or lower than the lower limit vehicle speed VPGENSOC for performing electric power generation based on the state of charge, the electric power generation flag F_GEN=“0” is set and the electric power generation by the auxiliary power part 33 is stopped in step S202. Then, the electric power generation judgment routine is terminated.

When it is determined that the vehicle speed VP is higher than the lower limit vehicle speed VPGENDOD for performing electric power generation based on the depth of discharge in step S206 or it is determined that the vehicle speed VP is higher than the lower limit vehicle speed VPGENSOC for performing electric power generation based on the state of charge in step S207, the electric power generation flag F_GEN=“1” is set and the electric power generation by the auxiliary power part 33 is started in step S208. Then, the electric power generation judgment routine is terminated.

Accordingly, when the depth of discharge DOD of the storage battery Ills increased or the state of charge SOC of the storage battery 11 is decreased, i.e. there is a possibility of over discharge of the storage battery 11, the over discharge of the storage battery 11 can be prevented beforehand by lowering the vehicle speed VP at which the auxiliary power part 33 is operated to start the electric power generation.

Next, an electric power generation amount calculation routine which is a subroutine of step S14 is described based on the flowchart of FIG. 5.

First, in step S401, an electric power generation amount PGENRL equivalent to an output required for cruising at each vehicle speed is retrieved from a table by using the vehicle speed VP as a parameter. The electric power generation amount PGENRL equivalent to an output required for cruising at each vehicle speed is an electric power generation amount to be generated by the auxiliary power part 33 which the electric motor 14 requires to generate a drive force overcoming the rolling resistance and the air resistance of the vehicle, and increases along with an increase in the vehicle speed VP.

In subsequent step S402, an electric power generation correction amount PGENSLP in each vehicle speed and gradient is retrieved from a map by using the vehicle speed VP and the estimated value θ of gradient of road surface which is calculated in aforementioned step S10 as parameters.

In subsequent step S403, an additional electric power generation amount PGENBASE in electric power generation at each vehicle speed is retrieved from a table by using the vehicle speed VP as a parameter. The additional electric power generation amount PGENBASE in electric power generation at each vehicle speed decreases along with an increase in the vehicle speed VP.

In subsequent step S404, an additional amount PGENDOD of electric power generation in each vehicle speed and depth of discharge is retrieved from a map by using the vehicle speed VP and the depth of discharge DOD as parameters. In step S405, an additional amount PGENSOC of electric power generation in each vehicle speed and state of charge is retrieved from a map by using the vehicle speed VP and the state of charge SOC as parameters. When the depth of discharge DOD is increased or the state of charge SOC is decreased, the additional electric power generation amount PGENBASE in electric power generation at each vehicle speed may be insufficient. Accordingly, the additional electric power generation amount PGENBASE in electric power generation at each vehicle speed is corrected by using the additional amount PGENDOD of electric power generation in each vehicle speed and depth of discharge and the additional amount PGENSOC of electric power generation in each vehicle speed and state of charge.

In subsequent step S406, an additional amount PGENAC of electric power generation during usage of air conditioner at each vehicle speed is retrieved from a table by using the vehicle speed VP as a parameter.

Then, in step S407, it is determined whether an air conditioner usage flag F_AC=“1” (air conditioner is used) is satisfied. When the air conditioner usage flag F_AC=“0” (no air conditioner is used) is satisfied and the electric compressor 22 and the electric heater 23 are not used, the electric generator electric power generation output PREQGEN is calculated in step S408 by adding up the electric power generation amount PGENRL equivalent to an output required for cruising at each vehicle speed, the electric power generation correction amount PGENSLP in each vehicle speed and gradient, the additional electric power generation amount PGENBASE in electric power generation at each vehicle speed, the additional amount PGENDOD of electric power generation in each vehicle speed and depth of discharge, and the additional amount PGENSOC of electric power generation in each vehicle speed and state of charge. Then, the electric power generation amount calculation routine is terminated.

Moreover, when the air conditioner usage flag F_AC=“1” is satisfied and the electric compressor 22 or the electric heater 23 is used in step S407, the electric generator electric power generation output PREQGEN is calculated in step S409 by adding up the electric power generation amount PGENRL equivalent to an output required for cruising at each vehicle speed, the electric power generation correction amount PGENSLP in each vehicle speed and gradient, the additional electric power generation amount PGENBASE in electric power generation at each vehicle speed, the additional amount PGENDOD of electric power generation in each vehicle speed and depth of discharge, the additional amount PGENSOC of electric power generation in each vehicle speed and state of charge, and the additional amount PGENAC of electric power generation during usage of air conditioner at each vehicle speed. Then, the electric power generation amount calculation routine is terminated.

In the embodiment, the auxiliary power part 33 is made to generate an output of an amount obtained by adding up the “electric power generation amount PGENRL equivalent to an output required for cruising at each vehicle speed” which is an output corresponding to the rolling resistance and the air resistance inevitably occurring when the vehicle travels and the “additional electric power generation amount PGENBASE in electric power generation at each vehicle speed” which is set as a predetermined extra amount. Meanwhile, the electric power stored in the storage battery 11 is used for an output temporarily required due to acceleration and the like and an output required for EV traveling at a low vehicle speed. In other words, it can be said that the control of the auxiliary power part 33 in the embodiment is a “cruising output following type electric power generation control”.

The “cruising output following type electric power generation control” solves the following problems of the conventional “requested output following type electric power generation control”, the problem being such that when a requested electric power generation amount required by the electric motor is large, the rotational speed of the internal combustion engine increases and largely deviates from the most fuel efficient point, and the fuel efficiency thereby drastically deteriorates when the vehicle travels by using the output of the auxiliary power part, another problem being such that, when the requested electric power generation amount is large, noise and vibrations are increased due to an increase in the rotational speed of the internal combustion engine. In addition, the “cruising output following type control” solves the following problem of the conventional “fixed-point operation type electric power generation control”, the problem being such that when the internal combustion engine is reduced in size and operated at the most fuel efficient point so as to reduce the fuel consumption and the exhaust amount of CO₂, the generated electric power amount of the electric generator cannot satisfy the requested drive force of the electric motor, and, as a result, the storage battery tends to be over discharged and maintaining of an energy level becomes difficult.

Moreover, the “electric power generation amount PGENRL equivalent to an output required for cruising at each vehicle speed” is set depending on the vehicle speed VP. Thus, the storage battery 11 can be charged by a surplus output of the electric generator 13 in downhill or deceleration. Accordingly, the frequency of electric power generation by the electric generator 13 in downhill or deceleration is increased and the maintaining of an energy level in the storage battery 11 is thereby further facilitated with no electric power generation of large output, which reduces the efficiency of the internal combustion engine 12, being performed.

Furthermore, in the embodiment, the “lower limit vehicle speed VPGENDOD for performing electric power generation based on the depth of discharge” and the “lower limit vehicle speed VPGENSOC for performing electric power generation based on the state of charge” which are vehicle speed for switching from the EV traveling to the REV traveling (i.e. traveling by electric power generated by the auxiliary power part 33) are changed depending on the state of charge SOC and the depth of discharge DOD of the storage battery 11. Accordingly, an energy control at low vehicle speed and low output can be appropriately performed.

In addition, the “electric power generation amount PGENRL equivalent to an output required for cruising at each vehicle speed” is corrected with the “electric power generation correction amount PGENSLP in each vehicle speed and gradient” during the REV traveling. Accordingly, the effect of the gradient of road surface is compensated and the electric power generation amount of the auxiliary power part 33 can be appropriately controlled. Moreover, the “additional electric power generation amount PGENBASE in electric power generation at each vehicle speed” is corrected with the “additional amount PGENDOD of electric power generation in each vehicle speed and depth of discharge”, the “additional amount PGENSOC of electric power generation in each vehicle speed and state of charge”, and the “additional amount PGENAC of electric power generation during usage of air conditioner at each vehicle speed”. Accordingly, the effects of the state of charge SOC, the depth of discharge DOD, and the load of air conditioner are compensated and the electric power generation amount of the auxiliary power part 33 can be thus appropriately controlled. Hence, an energy control at intermediate and high vehicle speeds and intermediate and high outputs can be appropriately performed.

An embodiment of the present invention has been described above. However, the present invention may be modified in variety of ways as long as the modifications do not depart from the gist of the invention.

For example, in the embodiment, description is given by using the plug-in hybrid automobile. However, the present invention can be also applied to a series hybrid automobile and a parallel hybrid automobile capable of series traveling.

Moreover, the calculation method of the depth of discharge DOD is not limited to one described in the embodiment and any method can be employed.

### REFERENCE SIGNS LIST

11 STORAGE BATTERY
12 INTERNAL COMBUSTION ENGINE
13 ELECTRIC GENERATOR
14 ELECTRIC MOTOR
22 ELECTRIC COMPRESSOR (AIR CONDITIONER)
23 ELECTRIC HEATER (AIR CONDITIONER)
24 CONTROL DEVICE
DOD DEPTH OF DISCHARGE
PGENRL ELECTRIC POWER GENERATION AMOUNT EQUIVALENT TO OUTPUT REQUIRED FOR CRUISING AT EACH VEHICLE SPEED
PGENBASE ADDITIONAL ELECTRIC POWER GENERATION AMOUNT IN ELECTRIC POWER GENERATION AT EACH VEHICLE SPEED
SOC STATE OF CHARGE
VP VEHICLE SPEED
θ ESTIMATED VALUE OF GRADIENT OF ROAD SURFACE

1. An electric power generation control system for a hybrid automobile, comprising:
an electric generator driven by an internal combustion engine;
a storage battery storing electric power generated by the electric generator; and
a control device controlling the internal combustion engine and the electric generator, wherein
the control device judges whether electric power generation of the electric generator is to be performed depending on a state of the storage battery,
when permitting the electric power generation, the control device sets an electric power generation amount equivalent to an output required for cruising, depending on a traveling state, and also sets an additional electric power generation amount according to an electric power amount required depending on a vehicle state and the traveling state, and
the control device controls the internal combustion engine and the electric generator on the basis of the electric power generation amount and the additional electric power generation amount.

2. The electric power generation control system for a hybrid automobile according to claim 1, wherein the control device judges whether the electric power generation is to be performed on the basis of a depth of discharge of the storage battery.

3. The electric power generation control system for a hybrid automobile according to claim 1, wherein the control device judges whether the electric power generation is to be performed on the basis of a state of charge of the storage battery.

4. The electric power generation control system for a hybrid automobile according to claim 1, wherein the control device sets the electric power generation amount on the basis of a vehicle speed.

5. The electric power generation control system for a hybrid automobile according to claim 4, wherein the control device derives a rolling resistance and an air resistance during traveling on the basis of the vehicle speed and sets the electric power generation amount on the basis of the derived rolling resistance and the derived air resistance.

6. The electric power generation control system for a hybrid automobile according to claim 1, wherein the control device sets the additional electric power generation amount on the basis of an estimated value of a gradient of a road surface.

7. The electric power generation control system for a hybrid automobile according to claim 1, wherein the control device sets the additional electric power generation amount on the basis of a depth of discharge of the storage battery.

8. The electric power generation control system for a hybrid automobile according to claim 1, wherein the control device sets the additional electric power generation amount on the basis of a state of charge of the storage battery.

9. The electric power generation control system for a hybrid automobile according to claim 1, wherein the control device sets the additional electric power generation amount on the basis of a vehicle speed.

10. The electric power generation control system for a hybrid automobile according to claim 1, further comprising an air conditioner performing air conditioning in a vehicle compartment, wherein
the control device judges whether the air conditioner is operating, and
when the air conditioner is operating, the control device sets the additional electric power generation amount depending on a requested temperature of the air conditioner.

11. The electric power generation control system for a hybrid automobile according to claim 1, wherein the control device corrects the additional electric power generation amount depending on a vehicle speed.

12. The electric power generation control system for a hybrid automobile according to claim 1, wherein the control device sets a rotational speed of the internal combustion engine on the basis of the electric power generation amount and the additional electric power generation amount.

13. An electric power generation control system for a hybrid automobile, comprising:
an electric generator driven by an internal combustion engine;
a storage battery storing electric power generated by the electric generator;
an air conditioner performing air conditioning in a vehicle compartment; and
a control device controlling the air conditioner, the internal combustion engine, and the electric generator, wherein
the control device judges whether electric power generation is to be performed on the basis of at least any one of parameters including a depth of discharge and a state of charge of the storage battery,
when permitting the electric power generation, the control device derives at least any one of resistances including an air resistance and a rolling resistance during traveling on the basis of a vehicle speed and sets an electric power generation amount equivalent to an output required for cruising on the basis of the derived resistance, and
the control device sets an additional electric power generation amount on the basis of at least any one of parameters including an estimated value of a gradient of a road surface, the depth of discharge of the storage battery, the state of charge of the storage battery, the vehicle speed, and a requested temperature of the air conditioner, and sets a rotational speed of the internal combustion engine on the basis of the set electric power generation amount and the set additional electric power generation amount.
